(19) United States
(12) Patent Application Publication
(10) Pub. No.: US 2011/0026579 A1
(43) Pub. Date: Feb. 3, 2011

(54) NOVEL EQUALIZER FOR SINGLE CARRIER TERRESTRIAL DTV RECEIVER

(75) Inventor: LIN YANG, FREMONT, CA (US)

Correspondence Address: FRANK F. TIAN, 1300 SW Campus Drive No.5-7, Federal Way, WA, 98023, US

(73) Assignee: LEGEND SILICON CORP., FREMONT, CA (US)

(21) Appl. No.: 12/512,901

(22) Filed: Jul. 30, 2009

(51) Int. Cl. H04L 27/01

(52) U.S. Cl. 375/233

(57) ABSTRACT

An equalizer is provided. The equalizer comprises a frequency domain a minimum-mean square-error (MMSE) decision feedback equalization (DFE) block having a backward filter co-efficient (BFC) feature adapted to operate in a single carrier environment.

### FIELD OF THE INVENTION

The present invention relates generally to an application in a digital television system, more specifically the present invention relates to a novel equalizer for single carrier terrestrial digital television receiver.

### BACKGROUND

Single carrier terrestrial digital television (DTV) systems are deployed in the countries such as Unite States (ATSC or Advanced Television Systems Committee), China (DMB-T/H or Digital Multimedia Broadcasting Terrestrial/Handheld), Canada, and other countries. Note that the China DTV standard is partially single carrier.

Single carrier DTV receiver is using DFE (Decision feedback equalizer) to combat the multipath interference introduced in the broadcast transmission of TV signals. Antenna Diversity has been successfully used in multi-carrier (i.e. OFDM, or Orthogonal Frequency Domain Multiplex) transmission systems, such as DVB-T for Europe DTV and ISDB-T for Japan DTV systems. However, antenna diversity has not been effectively used for single carrier DTV systems. Instead of using MRC (maximum ratio combining) technique for the antenna diversity in multi-carrier (OFDM) systems, single carrier DTV receivers usually use selective combining techniques.

United States Published patent application number 20090161748 entitled MMSE-DFE EQUALIZATION WITH ANTENNA DIVERSITY FOR MOBILE DTV to Wang, which is hereby incorporated herein by reference, describes a decision feedback equalizer having a feedback filter and K feed forward filter branches. Each of the K feed forward filter branches receives an input signal from a corresponding one of a plurality of channels associated with a corresponding one of a plurality of antennas, where K>1. Each of the K feed forward filter branches provides an output. Those outputs will be selectively chosen based on a threshold scheme described by the inventor for selective combining. However, Wang teaches space diversity with selective combining.

In terrestrial digital television (DTV) broadcasting, it is known that severe frequency selective fading is one of the major sources of signal degradation. Multipath effect as a cause of this frequency selective fading is known in that multiple copies of the transmitted signal travel to the receiver through different paths. It is further known that Multipath effects intersymbol interference (ISI) at the receiver level resulting in data errors if no effective equalization is performed. Multipath is more profound in the context of indoor and mobile DTV where the receiver is installed inside a room or in a vehicle adapted to move in that the receiver is a non-fixed point receiver.

It is known that in the non-fixed point receiver context, the wireless channel varies and becomes uncorrelated over a short period of time. Deep fades occur more frequently than in the fixed point context. Recently, linear equalization techniques, based on the zero-forcing (ZF) constraint or the minimum mean squared error (MMSE) criterion, have been extensively investigated. Due to mathematical tractability and desirable simplicity of the ZF or MMSE, both techniques have been widely documented in the wireless communication literature.

The challenge is to design a robust equalizer for indoor and/or mobile applications. One of the solutions is to use a nonlinear decision-feedback equalizer (DFE). A DFE has been shown to have significant performance advantages over linear equalizers. Further, the DFE has simplicity as compared to the discouraging complexity of optimum nonlinear equalizers. For practical purposes, some form of updating process, such as the least mean square (LMS) and the recursive least squares (RLS) algorithms, is used to update decision-feedback equalizers for changing channel conditions. However, when there is a precipitous fade, the tracking loops of decision-feedback equalizers may lose lock, resulting in a convergence problem (divergence of the receiving system). If divergence occurs, errors will propagate throughout the data stream until the equalizer is reinitialized. The consequence of this error propagation is serious for decision-feedback equalizer receivers due to their inherent error propagation deficiencies.

An alternative to using the above mentioned adaptive algorithms (LMS, RLS), there is direct coefficient calculation algorithms based on block data processing for fast adapt to the channels profile change. See “Block Channel Equalization in the Frequency Domain” by F. Pancaldi, et al, which is hereby incorporated herein by reference, IEEE Transactions on Communications, Volume 53, Issue 3, March 2005 Page(s): 463-471. In which channel equalization algorithms processing a block of the received signal and operating in the frequency domain are described in a unifying framework. First, minimum mean-square error linear and decision-feedback equalizers are derived, and a synthesis technique based on the well-known Levinson-Durbin algorithm is proposed for the latter. Then, iterative linear and decision-feedback equalization algorithms for turbo processing are devised. Performance results for both uncoded and coded phase-shift keying transmissions show the efficacy of the proposed equalization techniques and their superiority over other existing frequency-domain equalization strategies. However, Panacaldi teaches only single channel B_{dfe} and uses a known algorithm.

This class of block equalizers for single carrier DTV receiver requires channel estimation before equalization. There are many channel estimation algorithms that can be used for this purpose. In this invention, we assume the channel estimation has been done.

Another promising solution to indoor and mobile DTV receivers is to employ antenna diversity at the receiver. Theoretically, as long as two antennas are separated by more than half a wavelength, the channel characteristics of the two paths are independent. Hence, the probability of concurrent deep fades is small. When one channel fades, accurate symbol decisions can still be obtained from the other channel, so that the update process can continue without divergence. Thus, system performance is significantly improved with joint operation of the multiple antennas. However, the spectrum of the terrestrial DTV is allocated in within 900 MHz, the wavelength is longer than one feet. The physical dimension limitation on a receiver may not be able to accommodate multiple antennae with space diversity requirements.

Therefore, it is desirous to have multiple tuners for either one antenna receiver, or multiple antennae and using the tuner's independent noise characteristic, and to have maximum ratio combining for the multiple tuner inputs, and to have Minimum Mean Square Error Decision Feedback Equalizer to remove multipath interference for single carrier terrestrial digital television receiver.

### SUMMARY OF THE INVENTION

A method and device for block channel equalization having superposition diversity feature for single carrier transmission system are provided. In the present invention, we referred to Superposition Diversity as Super Diversity.

A method and device for an improved block channel equalization in the frequency domain having minimum mean square error decision feedback equalizer (MMSE-DFE) with reduced implementation complexity are provided.

A method and device for block channel equalization using multiple tuners having a novel maximum ratio combining (MRC) and minimum mean square error (MMSE) featured for Super Diversity are provided.

A single or multiple antennae digital receiver with Super Diversity gain is provided.

A single or multiple antennae terrestrial television (DTV) with Super Diversity gain is provided.

A single carrier terrestrial television (DTV) receiver having a single antenna or multiple antennae and a block channel equalization having a novel maximum ratio combining (MRC) and minimum mean square error (MMSE) features is provided.

A single carrier communication receiver with maximum ratio combining (MRC) and minimum mean square error (MMSE) features for Super Diversity is provided.

A single carrier communication receiver with MRC, and DFE features for Super Diversity is provided.

A single carrier terrestrial television (DTV) receiver having a block channel equalization and minimum mean square error (MMSE) features is provided.

An equalizer is provided. The equalizer comprises a frequency domain a minimum-mean square-error (MMSE) decision feedback equalization (DFE) block having a backward filter co-efficient (BFC) feature adapted to operate in a single carrier environment.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1A is a first example of a first receiver in accordance with some embodiments of the invention.

FIG. 1B is a second example of a first receiver in accordance with some embodiments of the invention.

FIG. 2 is an example of a maximum ratio combiner (FD-MRC-DFE) in accordance with some embodiments of the invention.

FIG. 3 is an example of a maximum ratio combiner (FE-MRC-EQ) in accordance with some embodiments of the invention.

FIG. 4 shows the computation of CE(k).

FIG. 5 further shows the computation of CE(k).

FIG. 6 shows the computation of MR(k).

FIG. 7 shows the computation of R(k)

FIG. 8 shows the computation of U(k).

FIG. 9 shows the computation of F(k).

FIG. 10 shows the computation of R(k).

FIG. 11 is a diagram for computing MRC.

FIG. 11A is a first detailed diagram depicting part of FIG. 11.

FIG. 11A-1 is a generic diagram of FIG. 11A.

FIG. 11B is a second detailed diagram depicting part of FIG. 11.

FIG. 11B-1 is a generic diagram of FIG. 11B.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to carrier recovery, symbol/timing recovery, frequency down conversion, baseband signal filter, frame synchronization, and channel estimation for the received multiple channel signals from either single or multiple antennae with multiple tuners and then using channel decoder to overcome bad data or error in a coding context. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” and terms of similar meaning should not be construed as limiting the item described to a given time period or to an item available as of a given time, but instead should be read to encompass conventional, traditional, normal, or standard technologies that may be available now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

It will be appreciated that embodiments of the invention described herein may be comprised of one or more conventional processors and unique stored program instructions that control the one or more processors to implement, channel estimation for received multiple channel signals. The non-processor circuits may include, but are not limited to, a radio receiver, a radio transmitter, signal drivers, clock circuits, power source circuits, and user input devices. As such, these functions may be interpreted as steps of a method to equalize the received multiple channel signals. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The present invention contemplates a wireless receiver not only used in DTV systems, but also used in such wireless systems as a personal digital assistant (PDA), a mobile PC, an Internet PC, a cell phone, or any WiMax or LTE device, as well as any mobile indoor device.

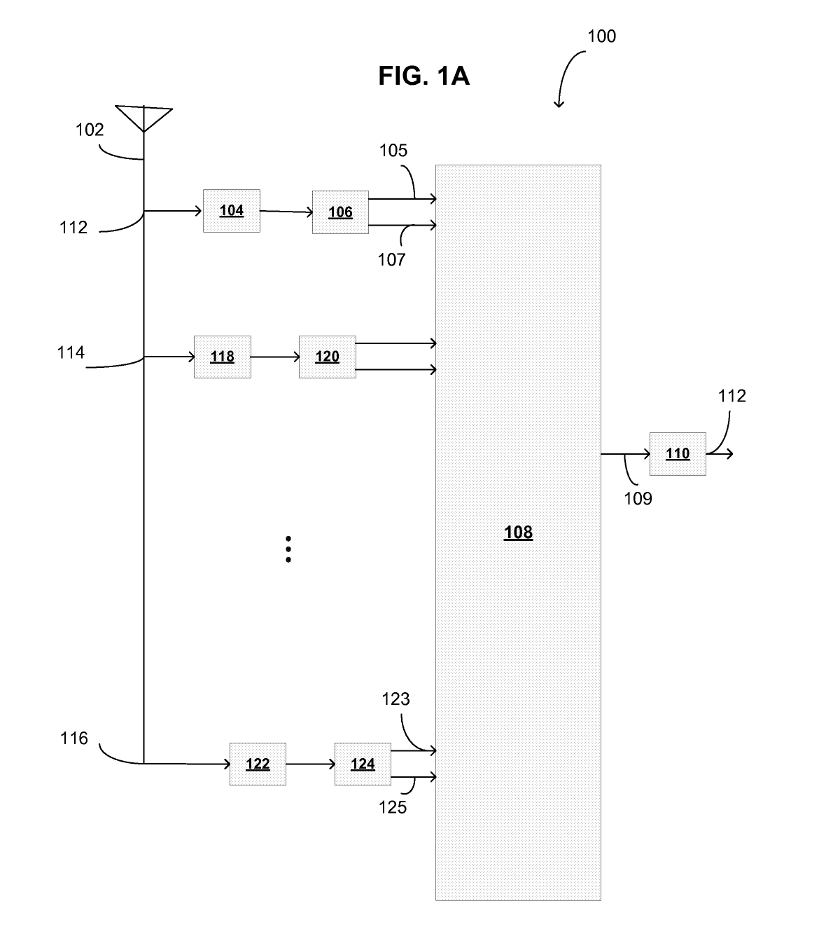

Referring to FIG. 1A, an example of a first receiver 100 in accordance with some embodiments of the invention is shown. A received signal is received by antenna 102. As can be seen, receiver 100 is a single antenna receiver such as a single antenna digital TV receiver with multiple tuners. In turn, a first tuner 104 processes the received signal. The tuner 104 generate its proprietary signal to noise ratio based upon the tuner's noise characteristics. The received signal, with tuner's noise characteristics, is subjected to preprocessing 106. Preprocessing comprises down conversion, carrier recovery, symbol/timing recovery, base-band signal filter, frame synchronization, Signal to Noise Ratio (SNR) and channel estimation. After preprocessing, the respective signal 105, along with its time domain channel estimation information 107 are separately input into a FD-MRC-DFE (i.e. Frequency Domain Maximum Ratio Combining Decision Feedback Equalizer) block 108. The output thereof is further subjected to down stream processing including Forward Error control (FEC) 110, etc. This forms the first signal path 112.

Similarly, for a second signal path 114, the received signal is received by antenna 102. In turn, a second tuner 118 processes the received signal. The tuners 118 generate its proprietary signal to noise ratio (SNR) based upon the tuner's noise characteristics. The received signal, with its noise characteristics, is subjected to preprocessing 120. Preprocessing comprises down conversion, carrier recovery, symbol/timing recovery, base-band signal filter, frame synchronization, Signal to Noise Ratio (SNR) and channel estimation. After preprocessing, the respective signal along with its time domain channel estimation information are separately input into a FD-MRC-DFE: Frequency Domain Maximum Ratio Combining Decision Feedback Equalizer block 108. The output thereof is further subjected to down stream processing including Forward Error Correction (FEC) 110, etc. This forms the second signal path 114. Note that only three paths are shown. However, in practice, up to N (N being a natural number, with N greater than or equal to 2) paths may be formed.

Therefore, generically, of the Nth path 116, the received signal is received by antenna 102. In turn, a first tuner 122 processes the received signal. The tuners 122 generate its proprietary signal to noise ratio based upon the tuner's noise characteristics. The received signal, with its noise characteristics, is subjected to preprocessing 124. Preprocessing comprises down conversion, carrier recovery, symbol/timing recovery, base-band signal filter, frame synchronization, Signal to Noise Ratio (SNR) and channel estimation. After preprocessing, the respective signal 123, with its time domain channel estimation information 125 are separately input into a FD-MRC-DFE: Frequency Domain Maximum Ratio Combining Decision Feedback Equalizer block 108. The output thereof is further subjected to down stream processing including Forward Error control (FEC) 110, etc.

Referring to FIG. 1B, an example of a second receiver 200 in accordance with some embodiments of the invention is shown. A received signal is received by a plurality of antennae comprising a set of N antennae (N being a natural number, with N greater than or equal to 2). Each antenna has its own tuner. Each antenna forms its own signal path.

A first tuner 204 processes the received signal. The tuners 204 generate its proprietary signal to noise ratio based upon the tuner's noise characteristics. The received signal, with its noise characteristics, is subjected to preprocessing 206 including, for example, Carrier recovery, symbol/timing recovery, down conversion, baseband filter, frame synchronization, Signal to Noise Ratio (SNR) channel estimation . . . , etc. After preprocessing, the respective signal 205 with its time domain channel estimation information 207 are input into a frequency domain maximum ratio combining-decision feedback equalizer block 108. The output thereof is further subjected to down stream processing including Forward Error control (FEC) 110, etc. This forms the first signal path 212.

Similarly, for a second signal path 2022, the received signal is received by antenna 2022. In turn, a second tuner 218 processes the received signal. The tuners 218 generate its proprietary signal to noise ratio based upon the tuner's noise characteristics. The received signal, with its noise characteristics, is subjected to preprocessing 220 (ex. Carrier recovery, symbol/timing recovery, down conversion, baseband filter, frame synchronization, channel estimation, etc). After preprocessing, the respective signal with its time domain channel estimation information are input into a frequency domain maximum ratio combining-decision feedback equalizer block 108. The output thereof is further subjected to down stream processing including Forward Error control (FEC) 210, etc. This forms the second signal path 212. Note that only three paths are shown. However, in practice, up to N (N being a natural number, with N greater than or equal to 2) paths may be formed.

Therefore, generically, of the Nth path 2024, the received signal is received by antenna 2024. In turn, a first tuner 222 processes the received signal. The tuners 222 generate its proprietary signal to noise ratio based upon the tuner's noise characteristics. The received signal, with its noise characteristics, is subjected to preprocessing 224. Preprocessing comprises down conversion, carrier recovery, symbol/timing recovery, base-band signal filter, frame synchronization, Signal to Noise Ratio (SNR) and channel estimation. After preprocessing, the respective signal 223, with its time domain channel estimation information 225 are separately input into a frequency domain maximum ratio combining-decision feedback equalizer block 108. The output thereof is further subjected to down stream processing including Forward Error control (FEC) 210, etc.

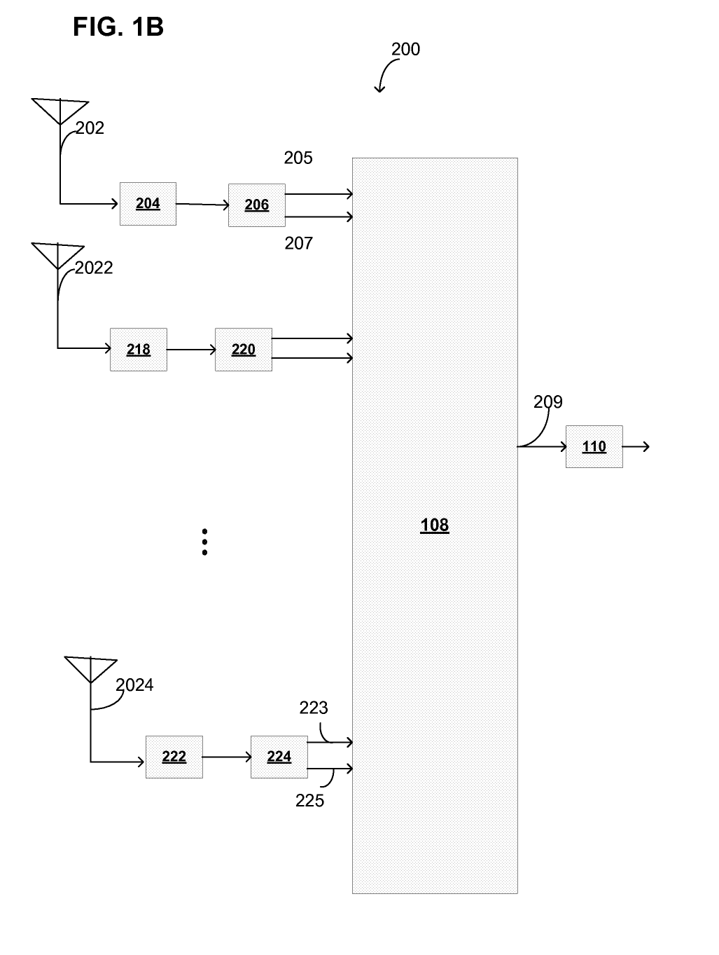

Referring to FIG. 2, is a first example of a frequency domain maximum ration combining decision feedback equalizer block 108 of either FIG. 1A, or FIG. 1B is shown. Received multiple channel signals 302 are fed into a frequency domain maximum ratio combiner equalizer (FD-MRC-EQ) 304. Received multiple channel signals 302 are denoted by r₁₋ₙ. a predetermined threshold value 305 is also fed into FD-MRC-EQ 304. The output of maximum ratio combiner-feedback decision equalizer 304 is fed into adder 306. The sum of adder 306 is input into the decision device 308. The output 310 of slicer or decision device 308 is fed down stream for further processing. Output 310 is fed back into a backward filter 312. The negative output of backward filter 312 is fed to adder 306. Channel estimation information 314, also denoted as CE(1−n), is fed to frequency domain maximum ratio combiner equalizer 304 as well as a minimum mean square backward filter coefficient (BFC) calculator 316. A SNR value is also fed into BFC 316. The output 307 of 316 is fed to the frequency domain maximum ratio combiner equalizer 304, as well as partially fed to a backward filter 312. The feed into FD-MRC-EQ 304 comprises a first vector having size m (m being a natural number). The feed into 312 comprises a second vector having size m−1. In other words, the first element of the first vector is not included in the second vector. To put the above in mathematical terms \tilde{v}\tilde{v₁}=(bfc₁, . . . , bfcₘ) and \tilde{v}\tilde{v₂}=(bfc₂, . . . , bfcₘ).

BFC stands for Backward Filter Coefficient calculation based on channel estimation (ce) of the multiple channel signals (r).

FD-MRC-EQ stands for Frequency Domain Maximum Ration Combining EQualizer received multiple channel signals 302 comprises a plurality of received multiple channel signals (r₁, r₂, . . . , r_{N}).

Channel estimation information 314 comprises a plurality of channel estimation of multiple channels (ce₁, ce₂, . . . , ce_{N}).

bfc stands for backward filter co-efficient value.

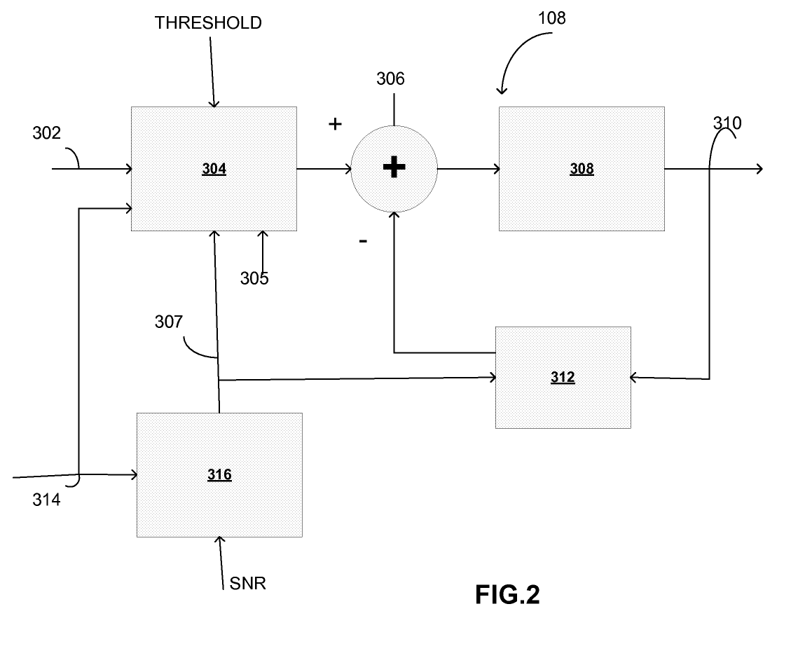

Referring to FIG. 3, an example of a frequency domain maximum ratio combiner equalizer (FD-MRC-EQ) 304 of FIG. 2 is shown. Received multiple channel signals 302 are respectively subjected to Fourier transform into frequency domain via a set of N fast Fourier transformers (FFT) 402. Similarly, Channel estimation information 314 are respectively subjected to Fourier transform into frequency domain via a set of N (N being a natural number greater than or equal to 2) fast Fourier transformers (FFT) 404. Further, the set of backward filter co-efficients (bfc) is subjected to Fourier transformation into frequency domain via a single fast Fourier transformers (FFT) 406. The output of 402, 404, and 406 are all input into a maximum ratio combiner (MRC) 408. The output of MRC 408 is transformed back into the time domain by an inverse Fourier transformer (IFFT) 410.

The driving of MRC are as follows.

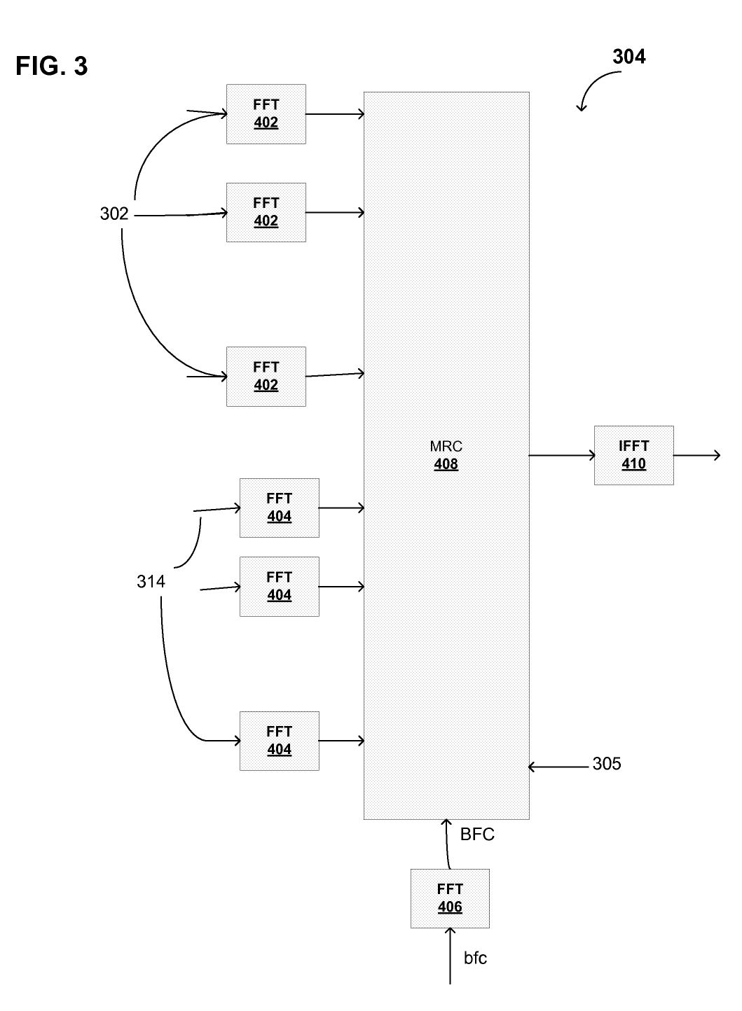

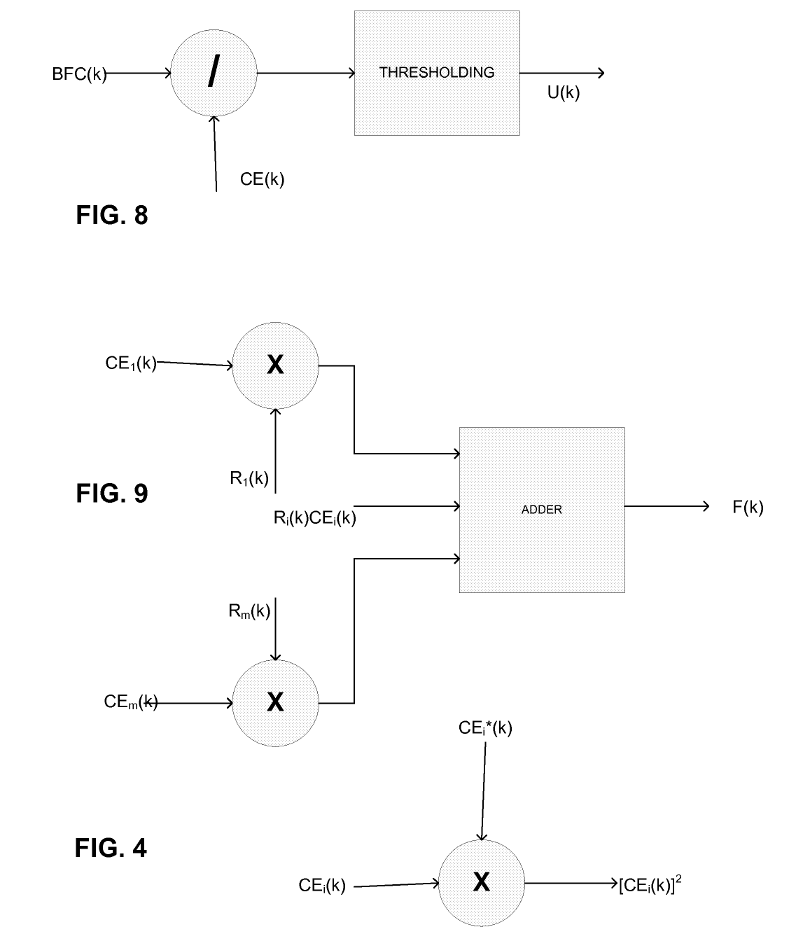

Referring to FIGS. 4-5, the computation of CE(k) is shown. each element is first multiplied with its own complements and then added up.

CE^{(k)}=CE(k)₁CE(k)₁*+ . . . +CE(k)ₘCE(k)ₘ*=Σᵢ₌₁^{m}=CEᵢ(k)CEᵢ*(k)

Where CEᵢ(k) is one of the channel estimations in frequency domain representation with i ranging from 1 to m, with m denoting the number of tuners.

Where k=1, . . . , N which span the FFT length.

Similarly

(1) The first method:

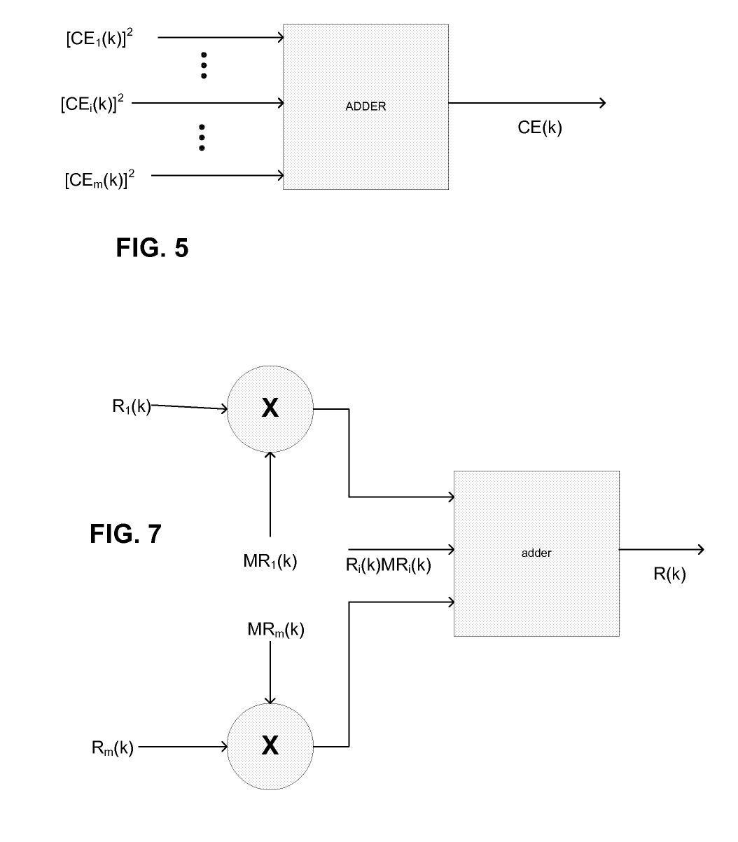

Referring to FIG. 6, the computation of MR(k) is shown

$$\begin{matrix}M {R}_{1} ( k ) = \frac{{CE}_{1}^{*} ( k )}{CE ( k )} BFC ( k ) \\ ⋮ \\ M {R}_{m} ( k ) = \frac{{CE}_{m}^{*} ( k )}{CE ( k )} BFC ( k )\end{matrix}$$

Note MRᵢ(k) may be truncated in order to limit the maximum value to a fixed number for reducing the noise enhancement effect. In other words, a predetermined value is set as the upper limit. Otherwise, the upper limit may be infinity.

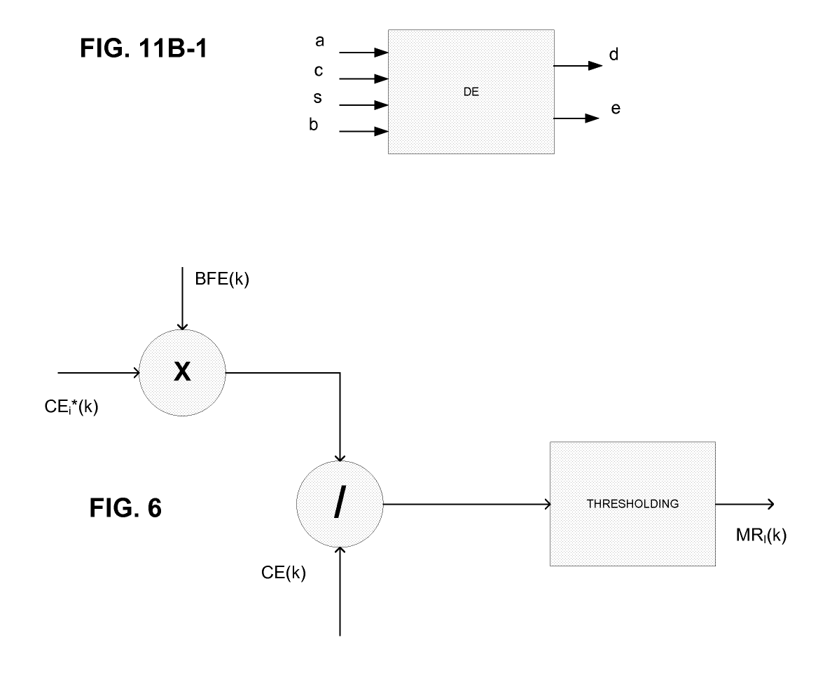

Referring to FIG. 7, the computation of R(k) is shown.

$$R ( k ) = {\sum }_{i = 1}^{m} {R}_{i} ( k ) * M {R}_{i} ( k )$$

As can be seen, there is only a single BFC value for i=1, . . . , m.

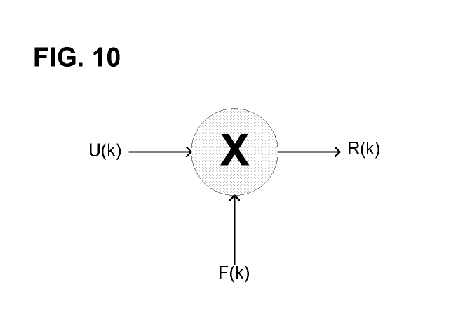

Referring to FIG. 8, the computation of U(k) is shown. the formula is listed below.

$$U ( k ) = \frac{1}{CE ( k )} BFC ( k )$$

Note U(k) may be truncated in order to limit the maximum value to a fixed number for reducing the noise enhancement effect. In other words, a predetermined value is set as the upper limit. Otherwise, the upper limit may be infinity.

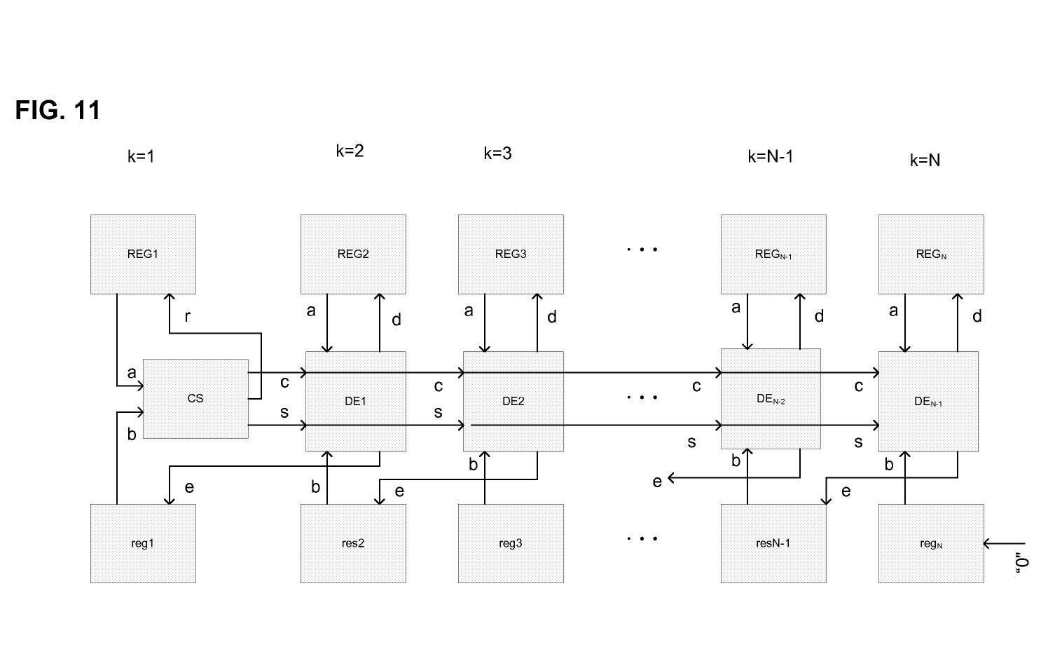

Referring to FIG. 9, the computation of F(k) is shown. The formula is listed below.

$$F ( k ) = {\sum }_{i = 1}^{m} {R}_{i} ( k ) \cdot {CE}_{i}^{*} ( k )$$

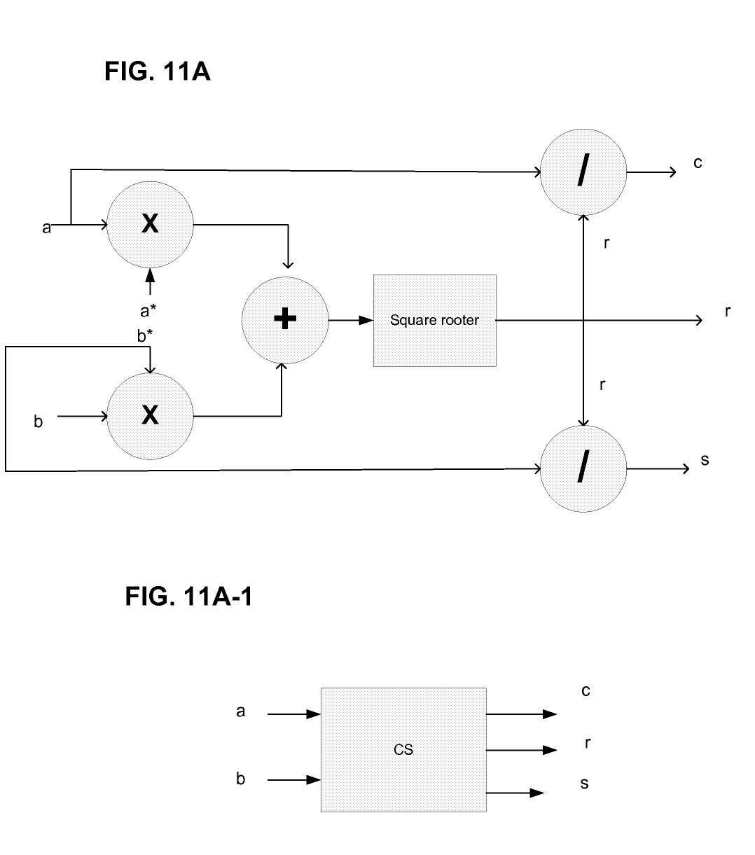

Referring to FIG. 10, the computation of R(k) is shown. the formula is listed below.

R(k)=U(k)F(k)

Wherein k=[1 . . . N] N being the length of FFT.

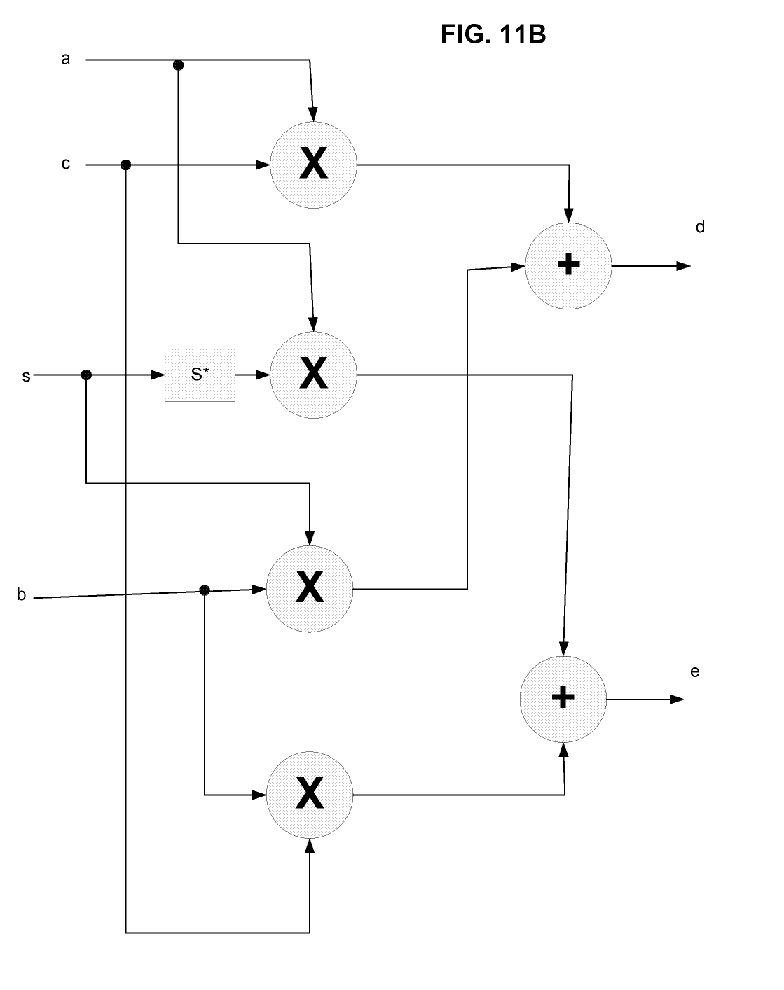

The following is the code associated with computing for BFC. Part of the computation is shown in FIGS. 11, 11A-B, etc.

Referring to FIG. 11, two sets of registers, REG and reg, are provided. Each set consists of N (being a natural number) registers with N being the length of FFT. A set of N−1 DE elements are provided. A CS element is provided. The flows are as shown. In other words, for CS, ‘a’ and ‘b’ feed thereinto. The output of CS is c and s respectively. An r also feeds back into REG1. ‘a’ also goes into its respective DE. ‘d’ gets out of its respective DE. ‘e’ feeds backward one element its respective DE. Note for reg_{N}, a zero is padded in.

Referring to FIG. 11A, internal structure of CS is shown. ‘a’ and its compliment ‘a*’ is multiplied to get |a|² and ‘b’ and its compliment ‘b*’ is multiplied to get |b|². In turn, both are summed to get |a|²+|b|². then the result is square-rooted \sqrt{|a|²+|b|²}. In turn, ‘c’, ‘r’, and ‘s’ are derived. Also refer to code lines 18-20.

Referring to FIG. 11A-1, a holistic view of FIG. 11A is shown. The inputs are a and b, the outputs are c, r, and s for block CS.

Referring to FIG. 11B, internal structure of DE is shown. ‘a’ is multiplied with ‘c’ and ‘s*’ respectively in both a first multiplier and a second multiplier. ‘c’ is multiplied with ‘a’ and ‘b’ respectively in both a first multiplier and a fourth multiplier. ‘s’ is first transformed to ‘s*’ and multiplied with ‘a’ and ‘b’ respectively in both a second multiplier and a third multiplier. ‘b’ is multiplied with ‘c’ and ‘s’ respectively in both a third multiplier and a fourth multiplier. The product of the first and third multiplier are summer to derive ‘d’. The product of the second and fourth multiplier are summer to derive ‘e’. Also refer to code lines 23-24.

Referring to FIG. 11B-1, a holistic view of FIG. 11B is shown. The inputs are a, c, s, and b, the outputs are d, and e for block DE.

The process is iterated as described in code lines 15-16, 22, and 29 by a system clock, which is NOT described or shown, until the resultant bfc, as code line 38, is generated.

The following is the code associated with FIG. 11. Note that under multiple tuner situations, a single set of bfc is used.

| 1 | Parameter definitions: | |
|---|---|---|
| 2 | chNum: the number of channel estimations (ce). | |
| 3 | chLength: the maximum length of all the channel estimations (ce). | |
| 4 | M: the number of backward filter coefficient | |
| 5 | nsr: the square root of the noise to signal ratio (predetermined) | |
| 6 | Initialization of the registers: | |
| 7 | sa0 (1,chLength) = 0 | |
| 8 | sa (1:chNum,1:chLength) = 0; | |
| 9 | sa0(1) = sqrt(nsr); | |
| 10 | for k = 1:chNum | |
| 11 | sa(k,1:chLength) = conj(ch(k,:)); | |
| 12 | end | |
| 13 | r1 = sa0(1); | |
| 14 | Iterative process: Refer to Fig.11 | |
| 15 | for i = 1:M; | -- iteration for the each bfc |
| 16 | for j = 1:chNum | -- iteration for the multiple channel |

| | |
|---|---|
| 17 | if sa(j,1) ~= 0 |
| 18 | r = sqrt(sa0(1)*sa0(1) + sa(j,1)*conj(sa(j,1))); |
| 19 | C = sa0(1)/r1; |
| 20 | S = conj(sa(j,1))/r1; |
| 21 | sa0(1) = r1; |
| 22 | for k = 2:chLength |
| 23 | sa0(k) = C*sa0(k)+S*sa(j,k); %for parallel processing |
| 24 | sa(j,k) = −conj(S)*sa0(k) + C*sa(j,k); |
| 25 | endfor line 22 |
| 26 | endif line 17 |
| 27 | endfor line 16 |
| 28 | if i < M |
| 29 | for j = 1:chNum |
| 30 | for k = 2:chLength |
| 31 | sa(j,k−1) = sa(j,k); |
| 32 | end for line 30 |
| 33 | sa(j,chLength) = 0; |
| 34 | end for line 29 |
| 35 | end if lin 28 |
| 36 | endfor line 15 |
| 37 | The result of the bfc |
| 38 | Bfc(1:chLength) = conj(sa0(1:chLength))/r1; |

The present invention contemplates the use of Superposition Diversity. Superposition Diversity technique is more general than Space Diversity technique, which is commonly used in the communication and DTV receivers for multi-carrier systems. Similar to Space Diversity, Superposition Diversity technique uses multiple copies of the received signals. The difference between Space Diversity and Superposition Diversity is that Space Diversity requires the multiple copies of the received signal to have independent channel characteristics and noise characteristics. On the other hand, Superposition Diversity requires only the independent noise characteristics for the multiple copies of the received signal. From the device implementation point of view, Space Diversity DTV receivers need multiple antennae with multiple tuners and Superposition Diversity DTV receivers only need multiple tuners with either a single antenna, or multiple antennae. The Super Diversity technique is not limited to DTV receivers. It can be used for any single carrier transmission communication systems.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. An equalizer comprising:
a frequency domain a minimum-mean square-error (MMSE) decision feedback equalization (DFE) block having a backward filter co-efficient (BFC) feature adapted to operate in a single carrier environment.

2. The equalizer of claim 1 is associated with a single antenna being coupled to a plurality of tuners having a maximum ratio combining (MRC) block.

3. The equalizer of claim 1 is associated with a plurality of antennae being coupled to a plurality of tuners having a maximum ratio combining (MRC) block.

4. The equalizer of claim 1, wherein the single carrier environment comprises the ATSC or the DMB-T/H standard.

5. The equalizer of claim 1, wherein the equalizer is used in a DTV receiver.

6. The equalizer of claim 1, wherein the equalizer is used in a mobile wireless receiver.

7. An equalization method comprising the steps of:
Providing a frequency domain a minimum-mean square-error (MMSE) decision feedback equalization (DFE) block having a backward filter co-efficient (BFC) feature adapted to operate in a single carrier environment.

8. The method of claim 7 is associated with a single antenna being coupled to a plurality of tuners having a maximum ratio combining (MRC) block.

9. The method of claim 7 is associated with a plurality of antennae being coupled to a plurality of tuners having a maximum ratio combining (MRC) block.

10. The method of claim 7, wherein the single carrier environment comprises the ATSC or the DMB-T/H standard.

11. The method of claim 7, wherein the equalizer is used in a DTV receiver.

12. The method of claim 7, wherein the equalizer is used in a mobile wireless receiver.

13. A receiver comprising:
an equalizer having:
a frequency domain a minimum-mean square-error (MMSE) decision feedback equalization (DFE) block having a backward filter co-efficient (BFC) feature adapted to operate in a single carrier environment.

14. The receiver of claim 13 comprises a single antenna being coupled to a plurality of tuners having a maximum ratio combining (MRC) block.

15. The receiver of claim 13 comprises a plurality of antennae being coupled to a plurality of tuners having a maximum ratio combining (MRC) block.

16. The receiver of claim 13, wherein the single carrier environment comprises the ATSC or the DMB-T/H standard.

17. The receiver of claim 13, wherein the equalizer is used in a DTV receiver.

18. The receiver of claim 13, wherein the equalizer is used in a mobile wireless receiver.
